(19) United States
(12) Patent Application Publication
(10) Pub. No.: US 2026/0208652 A1
(43) Pub. Date: Jul. 23, 2026

(54) DUMP TRUCK

(71) Applicant: KOMATSU LTD., Tokyo (JP)

(72) Inventor: Shota YAMAWAKI, Tokyo (JP)

(21) Appl. No.: 19/134,821

(22) PCT Filed: Dec. 7, 2023
(86) PCT No.: PCT/JP2023/043836

§ 371 Date: Jun. 2, 2025

(30) Foreign Application Priority Data
Dec. 28, 2022 (JP) 2022-211334

(51) Int. Cl. B60P 1/16; F15B 11/024

(52) U.S. Cl. CPC B60P 1/16; F15B 11/024

(57) ABSTRACT

A dump truck includes a dump body, a hoist cylinder that extends to raise the dump body and contracts when the dump body is lowered, a power source, and a motor. The motor operates to raise the dump body based on electric power supplied from the power source, and generates regenerative electric power by the dump body being lowered.

### CROSS-REFERENCE TO RELATED APPLICATIONS

This application is a U.S. National stage application of International Application No. PCT/JP2023/043836, filed on Dec. 7, 2023. This U.S. National stage application claims priority under 35 U.S.C. § 119(a) to Japanese Patent Application No. 2022-211334, filed in Japan on Dec. 28, 2022, the entire contents of which are hereby incorporated herein by reference.

### BACKGROUND

### Technical Field

The present disclosure relates to a dump truck.

### Background Information

In a technical field related to a dump truck, an articulated dump truck as disclosed in JP 2011-218920 A is known.

### SUMMARY

A dump truck includes a dump body and a hoist cylinder that raises and lowers the dump body. When the dump body is raised by the hoist cylinder, a load loaded on the dump body is discharged from the dump body. After the load is discharged from the dump body, the dump body is lowered. In order to improve energy efficiency of a dump truck, there is a demand for a technique for effectively utilizing energy generated when the dump body is lowered.

An object of the present disclosure is to effectively utilize energy generated when a dump body is lowered.

According to the present disclosure, provided is a dump truck including: a dump body; a hoist cylinder that extends to raise the dump body and contracts when the dump body is lowered; a power source; and a motor that operates to raise the dump body on a basis of electric power supplied from the power source and generates regenerative electric power by the dump body being lowered.

According to the present disclosure, energy generated when a dump body is lowered is effectively utilized.

### BRIEF DESCRIPTION OF DRAWINGS

FIG. 1 is a diagram schematically illustrating a dump truck according to a first embodiment.

FIG. 2 is a configuration diagram illustrating the dump truck according to the first embodiment.

FIG. 3 is a diagram illustrating a hydraulic system according to the first embodiment.

FIG. 4 is a diagram illustrating a hydraulic system according to a second embodiment.

FIG. 5 is a diagram illustrating a hydraulic system according to a third embodiment.

FIG. 6 is a diagram illustrating a hydraulic system according to a fourth embodiment.

FIG. 7 is a diagram illustrating a hydraulic system according to a fifth embodiment.

FIG. 8 is a diagram illustrating a hoist cylinder according to a sixth embodiment.

### DETAILED DESCRIPTION OF EMBODIMENT(S)

Hereinafter, embodiments according to the present disclosure will be described with reference to the drawings, but the present disclosure is not limited to the embodiments. Components of the embodiments described below can be appropriately combined. Furthermore, some components may not be used.

### First Embodiment

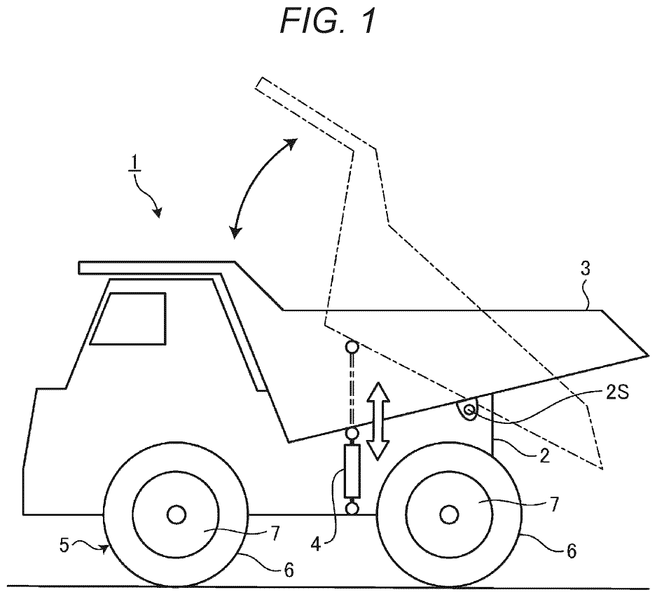

A first embodiment will be described. FIG. 1 is a diagram schematically illustrating a dump truck 1 according to the present embodiment. As illustrated in FIG. 1, the dump truck 1 includes a vehicle body frame 2, a dump body 3 supported by the vehicle body frame 2, a hoist cylinder 4 that raises and lowers the dump body 3, and a traveling device 5 that travels while supporting the vehicle body frame 2.

The traveling device 5 includes wheels 7 to which tires 6 are attached. The wheels 7 include two front wheels and two rear wheels. At least one of the front wheels and the rear wheels is steered by a steering device.

The dump body 3 is a member on which a load is loaded. The dump body 3 rotates around a support portion 2S included on the vehicle body frame 2. The hoist cylinder 4 raises and lowers the dump body 3. As the hoist cylinder 4 extends and contracts, the dump body 3 is raised and lowered. The hoist cylinder 4 extends to raise the dump body 3. The hoist cylinder 4 contracts when the dump body 3 is lowered. The hoist cylinder 4 may be contracted by the weight (action of gravity) of the dump body 3. When the dump body 3 is raised by the hoist cylinder 4, a load loaded on the dump body 3 is discharged from the dump body 3.

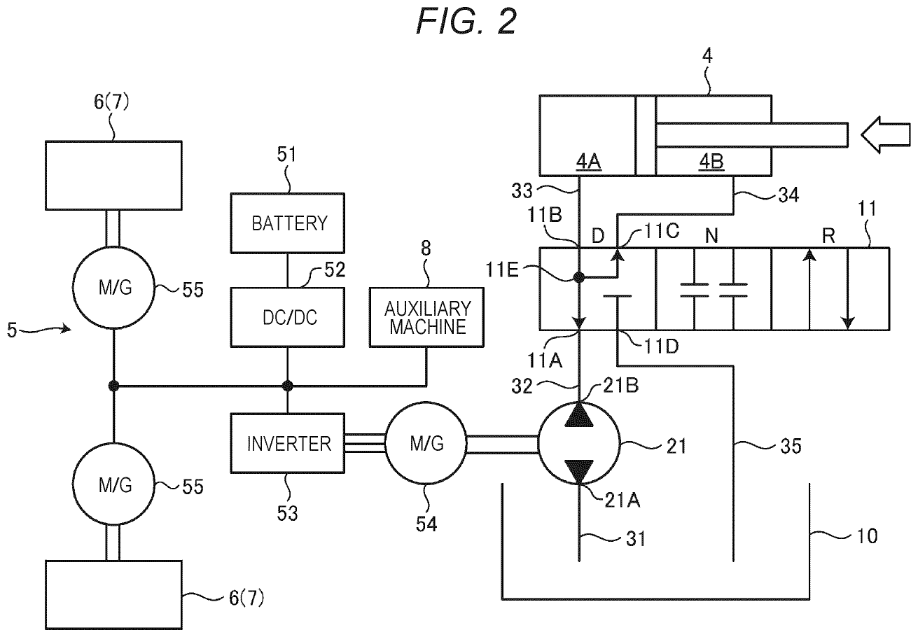

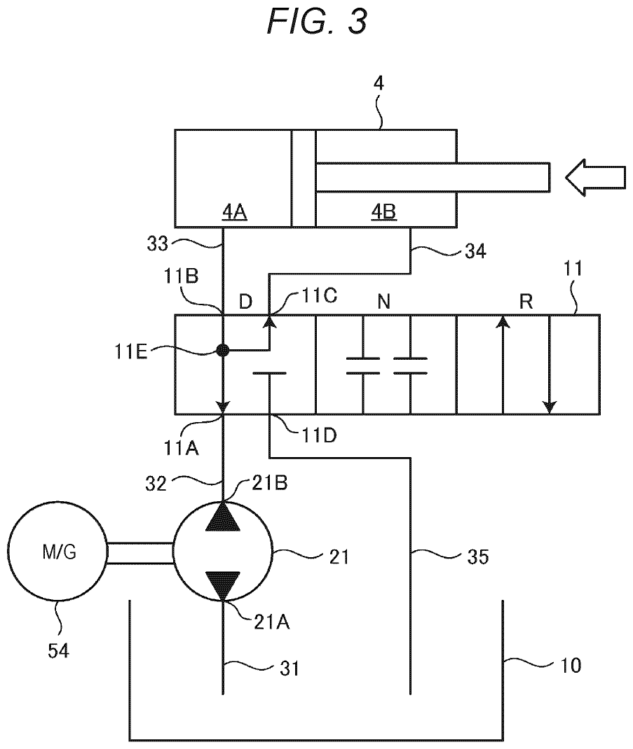

FIG. 2 is a configuration diagram illustrating the dump truck 1 according to the present embodiment. FIG. 3 is a diagram illustrating a hydraulic system according to the present embodiment, and is an enlarged view of a part of FIG. 2. As illustrated in FIGS. 2 and 3, the dump truck 1 includes the hoist cylinder 4, a hydraulic pump 21, an operation valve 11, a hydraulic oil tank 10, a battery 51, a DC/DC converter 52, an inverter 53, a drive motor 54, and traveling motors 55.

The hoist cylinder 4 extends to raise the dump body 3, and contracts when the dump body 3 is lowered. The hoist cylinder 4 is a hydraulic cylinder including a bottom chamber 4A and a rod chamber 4B. When hydraulic oil is supplied to the bottom chamber 4A, the hoist cylinder 4 is extended. When hydraulic oil is supplied to the rod chamber 4B, the hoist cylinder 4 is contracted.

The hydraulic pump 21 discharges hydraulic oil supplied to the hoist cylinder 4. In the present embodiment, the hydraulic pump 21 is a hydraulic pump/motor. The hydraulic pump 21 can function as a hydraulic motor. The hydraulic pump 21 includes a first inflow and outflow port 21A and a second inflow and outflow port 21B. The first inflow and outflow port 21 A and the hydraulic oil tank 10 are connected via a tank line 31. The hydraulic pump 21 is connected to the drive motor 54. When the dump body 3 is raised, the hydraulic pump 21 is driven by the drive motor 54. Hydraulic oil discharged from the hydraulic pump 21 is supplied to the hoist cylinder 4 via the operation valve 11.

The operation valve 11 adjusts the direction and flow rate of hydraulic oil supplied from the hydraulic pump 21 to the hoist cylinder 4. The operation valve 11 supplies hydraulic oil discharged from the hydraulic pump 21 to the bottom chamber 4A when the dump body 3 is raised. In the present embodiment, the operation valve 11 returns at least a part of the hydraulic oil discharged from the bottom chamber 4A to the hydraulic pump 21 when the dump body 3 is lowered.

The operation valve 11 includes a pump port 11A, a bottom port 11B, a rod port 11C, a tank port 11D, and a branch portion 11E. The pump port 11A is connected to the second inflow and outflow port 21B of the hydraulic pump 21 via a pump line 32. The bottom port 11B is connected to the bottom chamber 4A of the hoist cylinder 4 via a bottom line 33. The rod port 11C is connected to the rod chamber 4B of the hoist cylinder 4 via a rod line 34. The tank port 11D is connected to the hydraulic oil tank 10 via a tank line 35.

The operation valve 11 is movable to a raised position R, a neutral position N, and a lowered position D. When the dump body 3 is raised, the operation valve 11 is disposed at the raised position R. When the dump body 3 is lowered, the operation valve 11 is disposed at the lowered position D.

When the dump body 3 is raised, the operation valve 11 is disposed at the raised position R, and the hydraulic pump 21 is driven by the drive motor 54. When the hydraulic pump 21 is driven, hydraulic oil stored in the hydraulic oil tank 10 is sucked into the first inflow and outflow port 21A via the tank line 31. The hydraulic oil sucked into the first inflow and outflow port 21A is discharged from the second inflow and outflow port 21B of the hydraulic pump 21. When the operation valve 11 is disposed at the raised position R, the hydraulic oil discharged from the second inflow and outflow port 21B is supplied to the bottom chamber 4A of the hoist cylinder 4 via the pump line 32, the operation valve 11, and the bottom line 33. When the hydraulic oil is supplied to the bottom chamber 4A, the hoist cylinder 4 extends and the dump body 3 is raised. When the operation valve 11 is disposed at the raised position R, the hydraulic oil discharged from the rod chamber 4B is discharged to the hydraulic oil tank 10 via the rod line 34, the operation valve 11, and the tank line 35.

In a case where the dump body 3 is stopped, the operation valve 11 is disposed at the neutral position N. Since the operation valve 11 is disposed at the neutral position N, hydraulic oil is not supplied from the hydraulic pump 21 to the hoist cylinder 4, and hydraulic oil is not discharged from the hoist cylinder 4 to the hydraulic oil tank 10.

As illustrated in FIGS. 2 and 3, when the dump body 3 is lowered, the operation valve 11 is disposed at the lowered position D. When the dump body 3 is lowered, the hoist cylinder 4 contracts. When the hoist cylinder 4 contracts, hydraulic oil is discharged from the bottom chamber 4A. When the operation valve 11 is disposed at the lowered position D, the hydraulic oil discharged from the bottom chamber 4A is returned to the second inflow and outflow port 21B via the bottom line 33, the operation valve 11, and the pump line 32. The hydraulic oil returned to the second inflow and outflow port 21B is discharged from the first inflow and outflow port 21A to the hydraulic oil tank 10 via the tank line 31. When the dump body 3 is lowered, the hydraulic pump 21 rotates by the hydraulic oil returned from the bottom chamber 4A to the hydraulic pump 21 via the operation valve 11. When the dump body 3 is lowered, the hydraulic pump 21 functions as a hydraulic motor.

In the present embodiment, when the dump body 3 is lowered, the operation valve 11 distributes hydraulic oil discharged from the bottom chamber 4A to the hydraulic pump 21 and the rod chamber 4B. Hydraulic oil discharged from the bottom chamber 4A and flowing into the bottom port 11B via the bottom line 33 is branched into the pump port 11A and the rod port 11C at the branch portion 11E inside the operation valve 11. Hydraulic oil supplied from the branch portion 11E to the pump port 11A is returned to the second inflow and outflow port 21B via the pump line 32. Hydraulic oil supplied from the branch portion 11E to the rod port 11C is supplied to the rod chamber 4B via the rod line 34.

The battery 51 is a power source of the dump truck 1. As the battery 51, a lithium ion battery is exemplified.

The DC/DC converter 52 is connected to the battery 51. The DC/DC converter 52 converts the voltage of the battery 51. The DC/DC converter 52 boosts the voltage of the battery 51 by a predetermined boosting ratio. The DC/DC converter 52 is a bidirectional DC/DC converter capable of outputting electric power from the primary side to the secondary side and outputting electric power from the secondary side to the primary side. The primary side of the DC/DC converter 52 is a low voltage side (battery 51 side). The secondary side of the DC/DC converter 52 is a high voltage side (drive motor 54 and traveling motor 55 side).

The inverter 53 converts DC current from the DC/DC converter 52 into three-phase AC current and supplies the three-phase AC current to the drive motor 54. Electric power from the battery 51 is supplied to each of the inverter 53 and the traveling motor 55 via the DC/DC converter 52. The voltage of the battery 51 boosted by the DC/DC converter 52 is applied to each of the inverter 53 and the traveling motors 55. The drive motor 54 is driven on the basis of the three-phase AC current supplied from the inverter 53.

The drive motor 54 is a motor-generator that operates such that the dump body 3 is raised on the basis of electric power supplied from the battery 51 and generates regenerative electric power by the dump body 3 being lowered. The drive motor 54 is connected to the hydraulic pump 21. The drive motor 54 drives the hydraulic pump 21 on the basis of the electric power supplied from the battery 51 in order to raise the dump body 3. As described above, when the dump body 3 is lowered, the hydraulic pump 21 functions as a hydraulic motor. When the hydraulic pump 21 rotates as a hydraulic motor, the drive motor 54 connected to the hydraulic pump 21 is rotated. When the dump body 3 is lowered, the drive motor 54 is driven by the hydraulic pump 21. When the dump body 3 is lowered, the drive motor 54 functions as a generator. The drive motor 54 generates regenerative electric power on the basis of rotational force of the hydraulic pump 21 that rotates on the basis of hydraulic oil returned from the operation valve 11.

The battery 51 is charged by regenerative electric power from the drive motor 54 supplied via the DC/DC converter 52. The DC/DC converter 52 steps down the regenerative voltage of the drive motor 54 at a predetermined step-down ratio. The regenerative voltage of the drive motor 54 stepped down by the DC/DC converter 52 is applied to the battery 51. The battery 51 is charged by the regenerative voltage of the drive motor 54. Note that the battery 51 may be charged by a charging device that exists outside the dump truck 1.

The traveling motors 55 generate power for rotating the wheels 7. The traveling motors 55 operate on the basis of electric power supplied from the battery 51. The traveling motors 55 are motors/generators that generate regenerative electric power by deceleration of the wheels 7. The battery may be charged by regenerative electric power from the traveling motors 55.

Note that the regenerative electric power generated by the drive motor 54 may be supplied to the traveling motors 55 or an auxiliary machine 8 of the dump truck 1. The regenerative electric power generated by the traveling motors 55 may be supplied to the drive motor 54 or the auxiliary machine 8.

As described above, according to the embodiment, energy (potential energy, kinetic energy) generated when the dump body 3 is lowered is converted into regenerative electric power (regenerative energy). Since energy generated when the dump body 3 is lowered is effectively utilized, the energy efficiency of the dump truck 1 is improved.

When the dump body 3 is lowered, the hoist cylinder 4 contracts, and the hydraulic pump 21 rotates on the basis of hydraulic oil returned from the hoist cylinder 4 via the operation valve 11. Accordingly, when the dump body 3 is lowered, the drive motor 54 can generate regenerative electric power on the basis of the rotational force of the hydraulic pump 21.

When the dump body 3 is lowered, the operation valve 11 distributes hydraulic oil discharged from the bottom chamber 4A to the hydraulic pump 21 and the rod chamber 4B. When the hoist cylinder 4 contracts, hydraulic oil is supplied to the rod chamber 4B, thereby reducing negative pressure in the rod chamber 4B. Since negative pressure in the rod chamber 4B is reduced, generation of cavitation in the rod chamber 4B is reduced.

### Second Embodiment

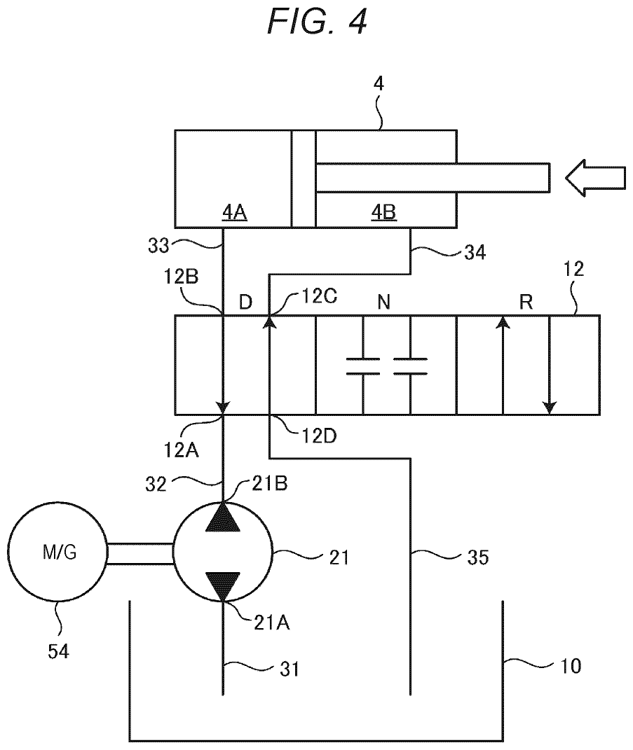

A second embodiment will be described. In the following embodiment, the same or equivalent components as those in the above-described embodiment are denoted by the same reference signs, and the description of the components is simplified or omitted. FIG. 4 is a diagram illustrating a hydraulic system according to the present embodiment. The second embodiment is a modification of the first embodiment.

As illustrated in FIG. 4, a hydraulic pump 21 includes a first inflow and outflow port 21A and a second inflow and outflow port 21B. The first inflow and outflow port 21A and a hydraulic oil tank 10 are connected via a tank line 31.

An operation valve 12 includes a pump port 12A, a bottom port 12B, a rod port 12C, and a tank port 12D. The pump port 12A is connected to the second inflow and outflow port 21B of the hydraulic pump 21 via a pump line 32. The bottom port 12B is connected to a bottom chamber 4A of a hoist cylinder 4 via a bottom line 33. The rod port 12C is connected to a rod chamber 4B of the hoist cylinder 4 via a rod line 34. The tank port 12D is connected to the hydraulic oil tank 10 via a tank line 35.

The operation valve 12 is movable to a raised position R, a neutral position N, and a lowered position D. When a dump body 3 is raised, the operation valve 12 is disposed at the raised position R. When the dump body 3 is lowered, the operation valve 12 is disposed at the lowered position D.

When the dump body 3 is lowered, hydraulic oil discharged from the bottom chamber 4A is returned to the second inflow and outflow port 21B via the bottom line 33, the operation valve 12, and the pump line 32. The hydraulic oil returned to the second inflow and outflow port 21B is discharged from the first inflow and outflow port 21 A to the hydraulic oil tank 10 via the tank line 31. When the dump body 3 is lowered, the hydraulic pump 21 rotates by the hydraulic oil returned from the bottom chamber 4A to the hydraulic pump 21 via the operation valve 12. When the dump body 3 is lowered, the hydraulic pump 21 functions as a hydraulic motor.

In the present embodiment, when the dump body 3 is lowered, hydraulic oil in the hydraulic oil tank 10 is sucked into the rod chamber 4B via the operation valve 12. When the operation valve 12 is disposed at the lowered position D, the rod chamber 4B and the hydraulic oil tank 10 are connected via the rod line 34, the operation valve 12, and the tank line 35. When the hoist cylinder 4 contracts when the dump body 3 is lowered, the pressure in the rod chamber 4B decreases, so that the hydraulic oil in the hydraulic oil tank 10 is sucked into the rod chamber 4B via the operation valve 12. When the hoist cylinder 4 contracts, hydraulic oil is supplied to the rod chamber 4B, thereby reducing occurrence of cavitation in the rod chamber 4B.

### Third Embodiment

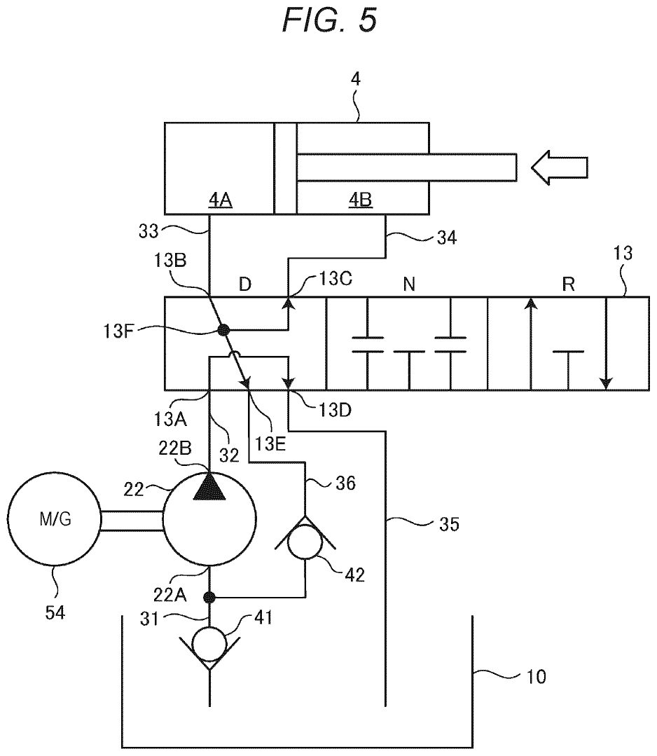

A third embodiment will be described. In the following embodiment, the same or equivalent components as those in the above-described embodiment are denoted by the same reference signs, and the description of the components is simplified or omitted. FIG. 5 is a diagram illustrating a hydraulic system according to the present embodiment.

As illustrated in FIG. 5, a hydraulic pump 22 includes a suction port 22A and a discharge port 22B. The suction port 22A and a hydraulic oil tank 10 are connected via a tank line 31.

An operation valve 13 includes a pump port 13A, a bottom port 13B, a rod port 13C, a tank port 13D, a return port 13E, and a branch portion 13F. The pump port 13A is connected to the discharge port 22B of the hydraulic pump 22 via a pump line 32. The bottom port 13B is connected to a bottom chamber 4A of a hoist cylinder 4 via a bottom line 33. The rod port 13C is connected to a rod chamber 4B of the hoist cylinder 4 via a rod line 34. The tank port 13D is connected to the hydraulic oil tank 10 via a tank line 35. The return port 13E is connected to the tank line 31 via a return line 36. The return line 36 is disposed so as to connect the operation valve 13 and the suction port 22A.

The operation valve 13 is movable to a raised position R, a neutral position N, and a lowered position D. When a dump body 3 is raised, the operation valve 13 is disposed at the raised position R. When the dump body 3 is lowered, the operation valve 13 is disposed at the lowered position D.

When the dump body 3 is raised, the operation valve 13 is disposed at the raised position R, and the hydraulic pump 22 is driven by a drive motor 54. When the hydraulic pump 22 is driven, hydraulic oil stored in the hydraulic oil tank 10 is sucked into the suction port 22A via the tank line 31. The hydraulic oil sucked into the suction port 22A is discharged from the discharge port 22B of the hydraulic pump 22. When the operation valve 13 is disposed at the raised position R, the hydraulic oil discharged from the discharge port 22B is supplied to the bottom chamber 4A of the hoist cylinder 4 via the pump line 32, the operation valve 13, and the bottom line 33. When the hydraulic oil is supplied to the bottom chamber 4A, the hoist cylinder 4 extends and the dump body 3 is raised. When the operation valve 13 is disposed at the raised position R, the hydraulic oil discharged from the rod chamber 4B is discharged to the hydraulic oil tank 10 via the rod line 34, the operation valve 13, and the tank line 35.

When the dump body 3 is lowered, the operation valve 13 is disposed at the lowered position D. When the operation valve 13 is disposed at the lowered position D and the hoist cylinder 4 contracts, the hydraulic oil discharged from the bottom chamber 4A is returned to the suction port 22A via the bottom line 33, the operation valve 13, and the return line 36. When the dump body 3 is lowered, the hydraulic pump 22 rotates by the hydraulic oil returned from the bottom chamber 4A to the hydraulic pump 22 via the operation valve 13. When the dump body 3 is lowered, the drive motor 54 is driven by the hydraulic pump 22.

The hydraulic oil returned to the suction port 22A is discharged from the discharge port 22B. In the present embodiment, when the dump body 3 is lowered, the operation valve 13 discharges the hydraulic oil discharged from the discharge port 22B to the hydraulic oil tank 10. The hydraulic oil discharged from the discharge port 22B flows into the pump port 13A via the pump line 32. In a state where the operation valve 13 is disposed at the lowered position D, the pump port 13A and the tank port 13D are connected inside the operation valve 13. The hydraulic oil flowing into the pump port 13A is discharged to the hydraulic oil tank 10 via the tank port 13D and the tank line 35.

In the present embodiment, when the dump body 3 is lowered, the operation valve 13 distributes hydraulic oil discharged from the bottom chamber 4A to the hydraulic pump 22 and the rod chamber 4B. Hydraulic oil discharged from the bottom chamber 4A and flowing into the bottom port 13B via the bottom line 33 is branched into the return port 13E and the rod port 13C at the branch portion 13F inside the operation valve 13. Hydraulic oil supplied from the branch portion 13F to the return port 13E is returned to the suction port 22A via the return line 36. Hydraulic oil supplied from the branch portion 13F to the rod port 13C is supplied to the rod chamber 4B via the rod line 34.

The return line 36 joins at a merging portion of the tank line 31. In the present embodiment, a shuttle valve 41 is disposed in the tank line 31 between the merging portion of the tank line 31 and the hydraulic oil tank 10. The shuttle valve 41 prevents hydraulic oil supplied from the return line 36 to the tank line 31 from being discharged to the hydraulic oil tank 10. The shuttle valve 41 reduces a decrease in the amount of hydraulic oil returned to the suction port 22A via the return line 36. In the present embodiment, a shuttle valve 42 is disposed on the return line 36. The shuttle valve 42 prevents hydraulic oil from the hydraulic oil tank 10 from being supplied to the return port 13E when the dump body 3 is raised.

As described above, in the present embodiment, in each of rising and lowering of the dump body 3, hydraulic oil is sucked from the suction port 22A and discharged from the discharge port 22B. That is, in the present embodiment, the rotation direction of the hydraulic pump 22 when the dump body 3 is raised is the same as the rotation direction of the hydraulic pump 22 when the dump body 3 is lowered.

When the dump body 3 is lowered, and the hydraulic pump 22 rotates on the basis of hydraulic oil returned from the operation valve 13. Accordingly, when the dump body 3 is lowered, the drive motor 54 can generate regenerative electric power on the basis of the rotational force of the hydraulic pump 22.

When the dump body 3 is lowered, the operation valve 13 distributes hydraulic oil discharged from the bottom chamber 4A to the hydraulic pump 22 and the rod chamber 4B. When the hoist cylinder 4 contracts, hydraulic oil is supplied to the rod chamber 4B, thereby reducing negative pressure in the rod chamber 4B. Since negative pressure in the rod chamber 4B is reduced, generation of cavitation in the rod chamber 4B is reduced.

### Fourth Embodiment

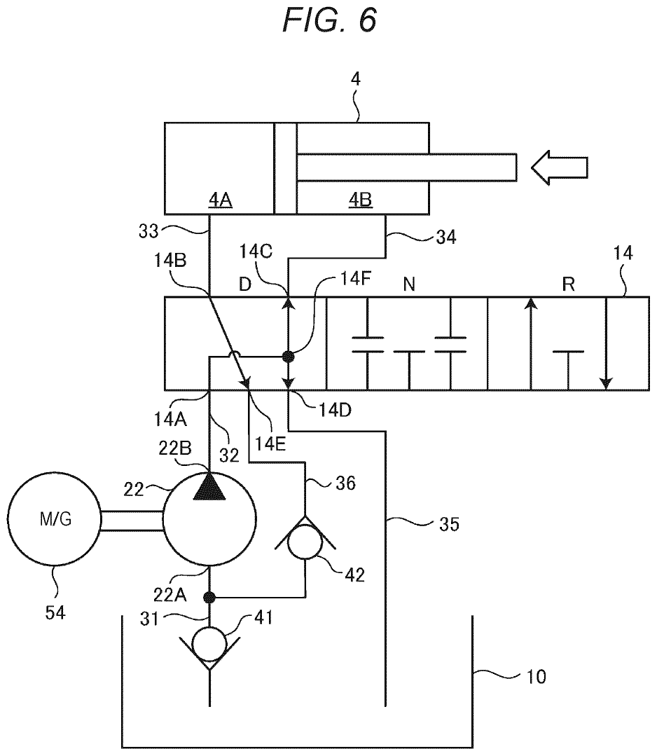

A fourth embodiment will be described. In the following embodiment, the same or equivalent components as those in the above-described embodiment are denoted by the same reference signs, and the description of the components is simplified or omitted. FIG. 6 is a diagram illustrating a hydraulic system according to the present embodiment. The fourth embodiment is a modification of the third embodiment.

As illustrated in FIG. 6, a hydraulic pump 22 includes a suction port 22A and a discharge port 22B. The suction port 22A and a hydraulic oil tank 10 are connected via a tank line 31.

An operation valve 14 includes a pump port 14A, a bottom port 14B, a rod port 14C, a tank port 14D, a return port 14E, and a branch portion 14F. The pump port 14A is connected to the discharge port 22B of the hydraulic pump 22 via a pump line 32. The bottom port 14B is connected to a bottom chamber 4A of a hoist cylinder 4 via a bottom line 33. The rod port 14C is connected to a rod chamber 4B of the hoist cylinder 4 via a rod line 34. The tank port 14D is connected to the hydraulic oil tank 10 via a tank line 35. The return port 14E is connected to the tank line 31 via a return line 36. The return line 36 is disposed so as to connect the operation valve 14 and the suction port 22A.

When a dump body 3 is lowered, the operation valve 14 is disposed at the lowered position D. When the operation valve 14 is disposed at the lowered position D and the hoist cylinder 4 contracts, hydraulic oil discharged from the bottom chamber 4A is returned to the suction port 22A via the bottom line 33, the operation valve 13, and the return line 36. When the dump body 3 is lowered, the hydraulic pump 22 rotates by the hydraulic oil returned from the bottom chamber 4A to the hydraulic pump 22 via the operation valve 14. When the dump body 3 is lowered, a drive motor 54 is driven by the hydraulic pump 22.

The hydraulic oil returned to the suction port 22A is discharged from the discharge port 22B. In the present embodiment, when the dump body 3 is lowered, the operation valve 14 distributes the hydraulic oil discharged from the discharge port 22B to the rod chamber 4B and the hydraulic oil tank 10. Hydraulic oil flowing into the pump port 14A from the discharge port 22B via the pump line 32 branches into the rod port 14C and the tank port 14D at the branch portion 14F inside the operation valve 14. Hydraulic oil supplied from the branch portion 14F to the rod port 14C is supplied to the rod chamber 4B via the rod line 34. Hydraulic oil supplied from the branch portion 14F to the tank port 14D is discharged to the hydraulic oil tank 10 via the tank line 35.

As described above, in the present embodiment, when the dump body 3 is lowered, hydraulic oil discharged from the bottom chamber 4A is distributed to the rod chamber 4B and the hydraulic oil tank 10 after passing through the hydraulic pump 22. When the dump body 3 is lowered, since the entire hydraulic oil discharged from the bottom chamber 4A is supplied to the hydraulic pump 22, the hydraulic pump 22 can rotate at a high speed. Therefore, the drive motor 54 can generate high regenerative electric power. Furthermore, when the hoist cylinder 4 contracts, hydraulic oil is supplied to the rod chamber 4B, thereby reducing negative pressure in the rod chamber 4B.

### Fifth Embodiment

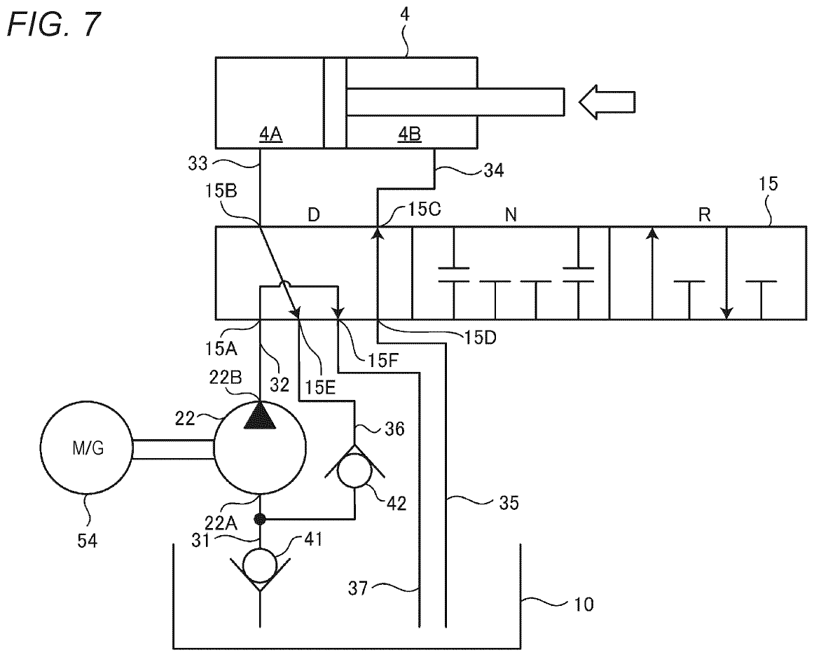

A fifth embodiment will be described. In the following embodiment, the same or equivalent components as those in the above-described embodiment are denoted by the same reference signs, and the description of the components is simplified or omitted. FIG. 7 is a diagram illustrating a hydraulic system according to the present embodiment. The fifth embodiment is a modification of the fourth embodiment.

As illustrated in FIG. 7, a hydraulic pump 22 includes a suction port 22A and a discharge port 22B. The suction port 22A and a hydraulic oil tank 10 are connected via a tank line 31.

An operation valve 15 includes a pump port 15A, a bottom port 15B, a rod port 15C, a tank port 15D, a return port 15E, and a tank port 15F. The pump port 15A is connected to the discharge port 22B of the hydraulic pump 22 via a pump line 32. The bottom port 15B is connected to a bottom chamber 4A of a hoist cylinder 4 via a bottom line 33. The rod port 15C is connected to a rod chamber 4B of the hoist cylinder 4 via a rod line 34. The tank port 15D is connected to the hydraulic oil tank 10 via a tank line 35. The return port 15E is connected to the tank line 31 via a return line 36. The return line 36 is disposed so as to connect the operation valve 15 and the suction port 22A. The tank port 15F is connected to the hydraulic oil tank 10 via a tank line 37.

When a dump body 3 is lowered, the operation valve 15 is disposed at the lowered position D. When the operation valve 15 is disposed at the lowered position D and the hoist cylinder 4 contracts, hydraulic oil discharged from the bottom chamber 4A is returned to the suction port 22A via the bottom line 33, the operation valve 15, and the return line 36. When the dump body 3 is lowered, the hydraulic pump 22 rotates by the hydraulic oil returned from the bottom chamber 4A to the hydraulic pump 22 via the operation valve 15. When the dump body 3 is lowered, a drive motor 54 is driven by the hydraulic pump 22.

The hydraulic oil returned to the suction port 22A is discharged from the discharge port 22B. In the present embodiment, when the dump body 3 is lowered, the operation valve 15 discharges the hydraulic oil discharged from the discharge port 22B to the hydraulic oil tank 10. In a state where the operation valve 15 is disposed at the lowered position D, the pump port 15A and the tank port 15F are connected inside the operation valve 15. The hydraulic oil flowing into the pump port 15A from the discharge port 22B via the pump line 32 is supplied to the tank port 15F. The hydraulic oil supplied to the tank port 15F is discharged to the hydraulic oil tank 10 via the tank line 37.

In the present embodiment, when the dump body 3 is lowered, hydraulic oil in the hydraulic oil tank 10 is sucked into the rod chamber 4B via the operation valve 15. When the operation valve 15 is disposed at the lowered position D, the rod chamber 4B and the hydraulic oil tank 10 are connected via the rod line 34, the operation valve 15, and the tank line 35. When the hoist cylinder 4 contracts when the dump body 3 is lowered, the pressure in the rod chamber 4B decreases, so that the hydraulic oil in the hydraulic oil tank 10 is sucked into the rod chamber 4B via the operation valve 15. When the hoist cylinder 4 contracts, hydraulic oil is supplied to the rod chamber 4B, thereby reducing occurrence of cavitation in the rod chamber 4B.

### Sixth Embodiment

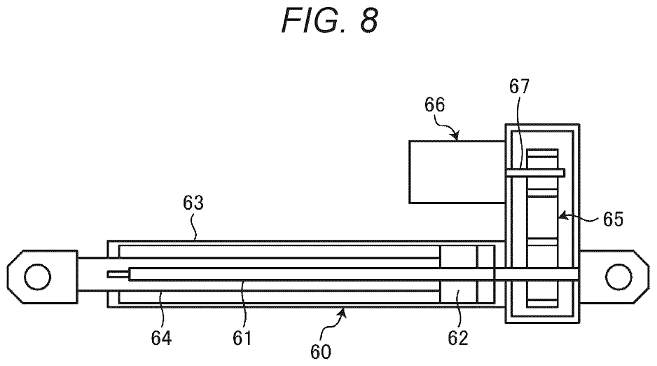

A sixth embodiment will be described. In the following embodiment, the same or equivalent components as those in the above-described embodiment are denoted by the same reference signs, and the description of the components is simplified or omitted. FIG. 8 is a diagram illustrating a hoist cylinder 60 according to the present embodiment. In the above-described embodiments, the hoist cylinder 4 is a hydraulic cylinder. The hoist cylinder 60 illustrated in FIG. 8 is an electric cylinder.

As illustrated in FIG. 8, the hoist cylinder 60 includes a shaft 61 in which a ball screw groove is formed, a slider 62 in which a ball engaged with the ball screw groove of the shaft 61 is incorporated, a cylinder 63 that movably accommodates the slider 62, and a piston 64 in which one end is fixed to the slider 62 and the other end side protrudes outwardly from the cylinder 63. The shaft 61 and the slider 62 form a ball screw. One end portion of the shaft 61 is connected to an output shaft 67 of a drive motor 66 via a power transmission mechanism 65. The power transmission mechanism 65 includes a plurality of gears. A proximal end portion of the cylinder 63 is connected to a vehicle body frame 2, and a distal end portion of the piston 64 is connected to a dump body 3. When the drive motor 66 rotates, the rotation of the drive motor 66 is converted into linear motion of the piston 64, and the dump body 3 is raised and lowered. When the dump body 3 is lowered, the shaft 61 rotates. The rotational force of the shaft 61 is transmitted to the drive motor 66 via the power transmission mechanism 65. The drive motor 66 rotates by the rotational force of the shaft 61 to generate regenerative electric power.

### OTHER EMBODIMENTS

In the above-described embodiments, the power source of the dump truck 1 is the battery 51. The power source of the dump truck 1 may be a fuel cell.

In the above-described embodiments, the dump truck 1 is a rigid frame dump truck. The dump truck 1 may be an articulated dump truck.

1. A dump truck comprising:
a dump body;
a hoist cylinder that extends to raise the dump body and contracts when the dump body is lowered;
a power source; and
a motor that
operates to raise the dump body based on electric power supplied from the power source, and
generates regenerative electric power by the dump body being lowered.

2. The dump truck according to claim 1, wherein
the power source includes a battery, and
the battery is charged by the regenerative electric power.

3. The dump truck according to claim 1, wherein
the hoist cylinder is a hydraulic cylinder including a bottom chamber and a rod chamber, and
the dump truck further comprises:
a hydraulic pump connected to the motor; and
an operation valve that
supplies hydraulic oil discharged from the hydraulic pump to the bottom chamber when the dump body is raised, and
returns at least a part of hydraulic oil discharged from the bottom chamber to the hydraulic pump when the dump body is lowered, and
the motor generates regenerative electric power based on a rotational force of the hydraulic pump that rotates based on hydraulic oil returned from the operation valve.

4. The dump truck according to claim 3, wherein
the hydraulic pump includes a first inflow and outflow port and a second inflow and outflow port,
hydraulic oil sucked into the first inflow and outflow port when the dump body is raised is discharged from the second inflow and outflow port, and
when the dump body is lowered, hydraulic oil discharged from the bottom chamber is returned to the second inflow and outflow port via the operation valve, and is discharged from the first inflow and outflow port to a hydraulic oil tank.

5. The dump truck according to claim 4, wherein
the operation valve distributes hydraulic oil discharged from the bottom chamber to the hydraulic pump and the rod chamber when the dump body is lowered.

6. The dump truck according to claim 4, wherein
hydraulic oil in the hydraulic oil tank is sucked into the rod chamber via the operation valve when the dump body is lowered.

7. The dump truck according to claim 3, wherein
the operation valve distributes hydraulic oil discharged from the bottom chamber to the hydraulic pump and the rod chamber when the dump body is lowered.

8. The dump truck according to claim 3, wherein
the hydraulic pump includes a suction port and a discharge port,
the dump truck further comprises a return line that connects the operation valve and the suction port,
hydraulic oil sucked into the suction port when the dump body is raised is discharged from the discharge port, and
when the dump body is lowered, hydraulic oil discharged from the bottom chamber is returned to the suction port via the operation valve and the return line.

9. The dump truck according to claim 8, wherein
the operation valve discharges hydraulic oil discharged from the discharge port to a hydraulic oil tank when the dump body is lowered.

10. The dump truck according to claim 3, wherein
the hydraulic pump includes a suction port and a discharge port,
the dump truck further comprises a return line that connects the operation valve and the suction port, and
when the dump body is lowered, hydraulic oil discharged from the bottom chamber is returned to the suction port via the operation valve and the return line.

11. The dump truck according to claim 10, wherein
the operation valve distributes hydraulic oil discharged from the discharge port to the rod chamber and a hydraulic oil tank when the dump body is lowered.

12. The dump truck according to claim 10, wherein
the operation valve discharges hydraulic oil discharged from the discharge port to a hydraulic oil tank when the dump body is lowered.

13. The dump truck according to claim 10, wherein
hydraulic oil in a hydraulic oil tank is sucked into the rod chamber via the operation valve when the dump body is lowered.

14. The dump truck according to claim 1, wherein
the hoist cylinder is an electric cylinder including a ball screw connected to the motor via a power transmission mechanism.
